(19) United States
(12) Patent Application Publication
(10) Pub. No.: US 2012/0193505 A1
(43) Pub. Date: Aug. 2, 2012

(54) VIBRATION ISOLATION SYSTEM FOR ROOFTOP MOUNTED HVAC EQUIPMENT

(76) Inventor: James A. Baron, Hilliard, OH (US)

(21) Appl. No.: 13/015,932

(22) Filed: Jan. 28, 2011

(51) Int. Cl. F16F 15/00

(52) U.S. Cl. 248/636

(57) ABSTRACT

A vibration isolation assembly for mounting a vibration source, such as a rooftop mounted condenser, includes a bottom tray and having a pair of flanges and a top tray adapted to support the vibration source thereon and having a pair of flanges. At least one vibration isolator is located between the top and bottom trays and secured to the top and bottom trays to isolate vibration produced by the vibration source. The flanges of the bottom tray and the flanges of the top tray are spaced apart when loaded by the vibration source to permit movement of the top tray relative to the bottom tray during normal operation of the vibration source and engage when wind loads are applied to the vibration source so that the wind loads transfer through the flanges of the top tray to the flanges of the bottom tray rather than through the vibration isolator.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to vibration isolation systems and, more particularly, to vibration isolation systems for rooftop mounted equipment.

### BACKGROUND OF THE INVENTION

Heating ventilating and air conditioning equipment (HVAC), particularly air conditioning condensers, is often mounted on building rooftops. Because this HVAC equipment is a vibration source, it can transfer vibration to the building structure. In some cases the building can noticeably move and shake. As a result, it is desirable to mount the HVAC equipment in a manner to isolate the building from the shocks and vibration produced by the HVAC equipment.

There are many means for isolating objects from shocks and vibration. Rooftop mounted condensers are often mounted on stands with springs located between the condenser and the stand so that the springs isolate the building from the shock and vibration produced by the condenser. While these springs are somewhat effective, they often do not completely isolate the condenser because they cannot be broadly applied across a wide spectrum of applications. One unique means of isolating objects from shocks and vibration has a flexible member supported on knife edge supports. For example, see U.S. Pat. Nos. 6,220,563, 6,595,483, and 7,086,509, the disclosures of which are expressly incorporated herein in their entireties by reference. These vibration isolation systems can be broadly applied across a wide spectrum of applications such as, for example, motors, marine engines, HVAC equipment such as compressors, house hold appliances such as clothes washing machines, and architectural applications such as buildings and bridges. While these systems are excellent for isolating objects from shock and vibration they may have limitations in rooftop applications where there are high winds and/or hurricanes because the wind loads must be carried through the flexible members.

In high wind and/or hurricane zones, it is important to mount rooftop equipment against dislodgement because of not only damage that can be caused to the roof and the HVAC equipment but also because the dislodged HVAC equipment can create an unprotected opening through which significant amounts of water can enter the building and the dislodged HVAC equipment can become air bourn debris that causes further damage and/or injury. Some states which frequently have high wind and/or hurricanes have building codes to address these issues. For example, the state of Florida has statewide building code ASCE 7-05. Accordingly, there is a need in the art for improved vibration isolation systems for use in rooftop applications.

### SUMMARY OF THE INVENTION

Disclosed are vibration isolation systems that overcome at least one of the disadvantages of the prior art described above. Disclosed is a vibration isolation assembly for mounting a vibration source that comprises, in combination, a bottom tray and having a pair of flanges, a top tray adapted to support the vibration source thereon and having a pair of flanges, and at least one vibration isolator located between the top and bottom trays and secured to the top and bottom trays to isolate vibration produced by the vibration source. The flanges of the bottom tray and the flanges of the top tray are spaced apart when loaded by the vibration source to permit movement of the top tray relative to the bottom tray during normal operation of the vibration source and engage when wind loads are applied to the vibration source so that the wind loads transfer through the flanges of the top tray to the flanges of the bottom tray rather than through the vibration isolator.

Also disclosed is a vibration isolation assembly for mounting a vibration source which comprises, in combination, an elongate bottom tray which is channel-shaped in cross-section and includes a horizontally extending base wall, side walls upwardly extending from lateral edges the base wall, and flanges extending from upper ends of the side walls, and an elongate top tray which is channel-shaped in cross-section and includes a horizontally extending base wall, side walls downwardly extending from lateral edges the base wall, and flanges extending from lower ends of the side walls. The base wall of the top tray is adapted to support the vibration source. A pair of longitudinally spaced-apart vibration isolators are located between the top and bottom trays and secured to the top and bottom trays to isolate vibration produced by the vibration source. The flanges of the bottom tray and the flanges of the top tray are spaced apart when loaded by the vibration source to permit movement of the top tray relative to the bottom tray during normal operation of the vibration source and engage when wind loads engage the vibration source so that the wind loads transfer through the flanges of the top tray to the flanges of the bottom tray rather than through the vibration isolators.

Also disclosed is a vibration isolation system comprising, in combination, a pair of laterally spaced-apart vibration isolation assemblies. Each of the vibration isolation assemblies comprise an elongate bottom tray which is channel-shaped in cross-section and includes a horizontally extending base wall, side walls upwardly extending from lateral edges the base wall, and flanges extending from upper ends of the side walls, an elongate top tray which is channel-shaped in cross-section and includes a horizontally extending base wall, side walls downwardly extending from lateral edges the base wall, and flanges extending from lower ends of the side walls, and a pair of longitudinally spaced-apart vibration isolators located between the top and bottom trays and secured to the top and bottom trays to isolate vibration produced by the vibration source. The vibration source supported on the top trays of the vibration isolation assemblies. The flanges of the bottom trays and the flanges of the top trays are spaced apart when loaded by the vibration source to permit movement of the top trays relative to the bottom trays during normal operation of the vibration source and engage when wind loads engage the vibration source so that the wind loads transfer through the flanges of the top trays to the flanges of the bottom trays rather than through the vibration isolators.

From the foregoing disclosure and the following more detailed description of various preferred embodiments it will be apparent to those skilled in the art that the present invention provides a significant advance in the technology and art of vibration isolation systems. Particularly significant in this regard is the potential the invention affords for a device that isolates shock and vibration but locks under high wind load and is relatively inexpensive to produce and maintain. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a perspective view of air conditioning condenser mounted on a rooftop stand with a vibration isolation system according to the present invention;

FIG. 2 is an enlarged, fragmented perspective view showing a portion of the vibration isolation system of FIG. 1 wherein an attachment bracket is removed for clarity;

FIG. 3 is an end elevational view of a vibration isolation assembly of the vibration isolation system of FIG. 1;

FIG. 4 is a perspective view of the vibration isolation assembly of FIG. 3, wherein an upper tray is removed for clarity;

FIG. 5 is a perspective view of the vibration isolation assembly of FIG. 3, wherein a lower tray is removed for clarity;

FIG. 6 is a side elevational view of the lower tray of the vibration isolation assembly of FIGS. 3 to 5;

FIG. 7 is an end elevational view of the lower tray of FIG. 6;

FIG. 8 is top plan view of the lower tray of FIGS. 6 and 7;

FIG. 9 is a perspective view of a bottom bushing bracket of the vibration isolation assembly of FIGS. 3 to 5;

FIG. 10 is a side elevational view of the upper tray of the vibration isolation assembly of FIGS. 3 to 5;

FIG. 11 is an end elevational view of the upper tray of FIG. 10;

FIG. 12 is top plan view of the upper tray of FIGS. 10 and 11;

FIG. 13 is a perspective view of a bottom bushing bracket of the vibration isolation assembly of FIGS. 3 to 5; and

FIG. 14 is a perspective view of an attachment bracket of the vibration isolation system of FIG. 1.

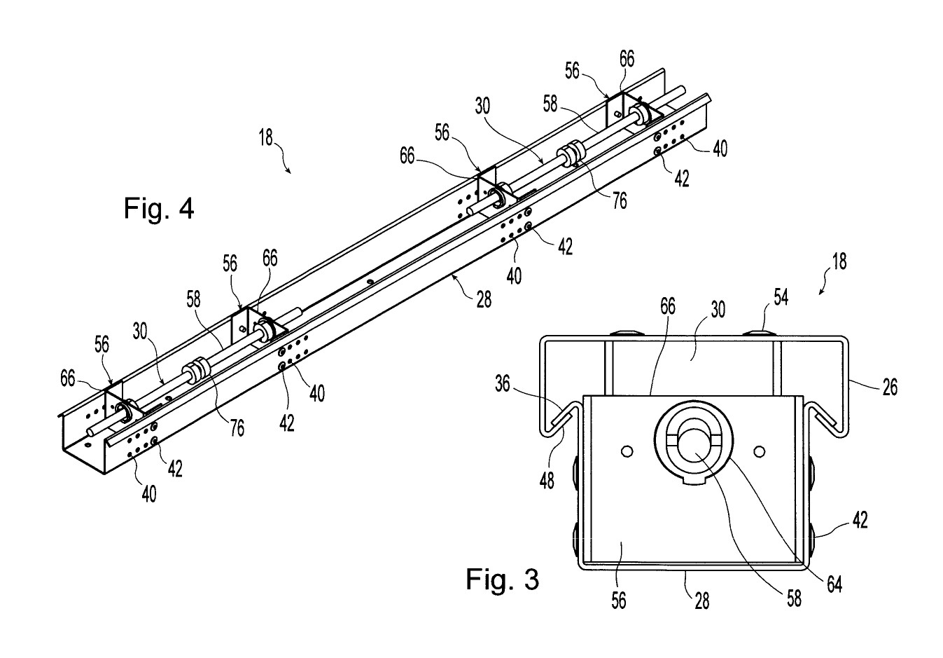

It should be understood that the appended drawings are not necessarily to scale, presenting a somewhat simplified representation of various preferred features illustrative of the basic principles of the invention. The specific design features of the vibration isolation systems as disclosed herein, including, for example, specific dimensions and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the vibration isolation systems illustrated in the drawings. In general, up or upward refers to an upward direction within the plane of the paper in FIG. 3 and down or downward refers to a downward direction within the plane of the paper in FIG. 3.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved vibration isolation systems disclosed herein. The following detailed discussion of various alternative and preferred embodiments will illustrate the general principles of the invention with regard to the specific application of a rooftop mounted air conditioning compressor. Other embodiments suitable for other applications will be apparent to those skilled in the art given the benefit of this disclosure.

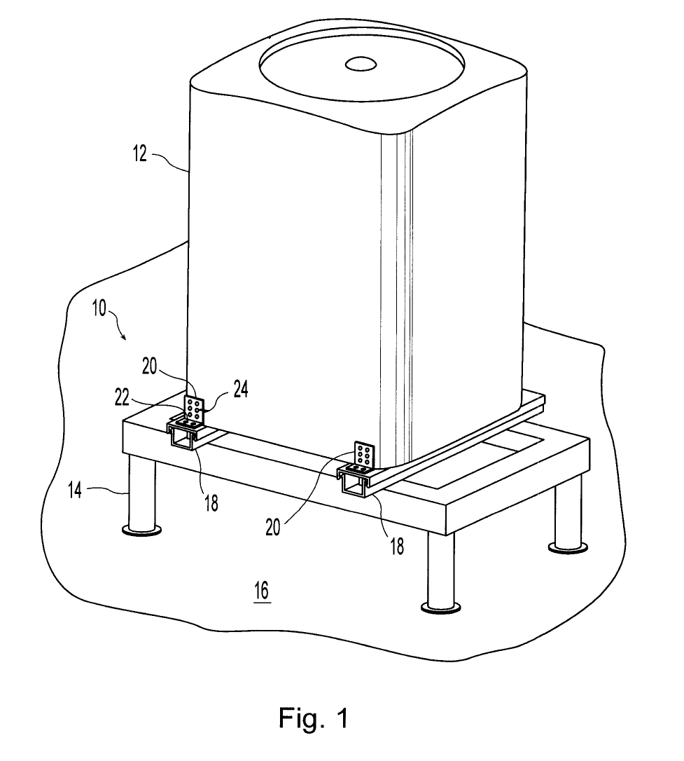

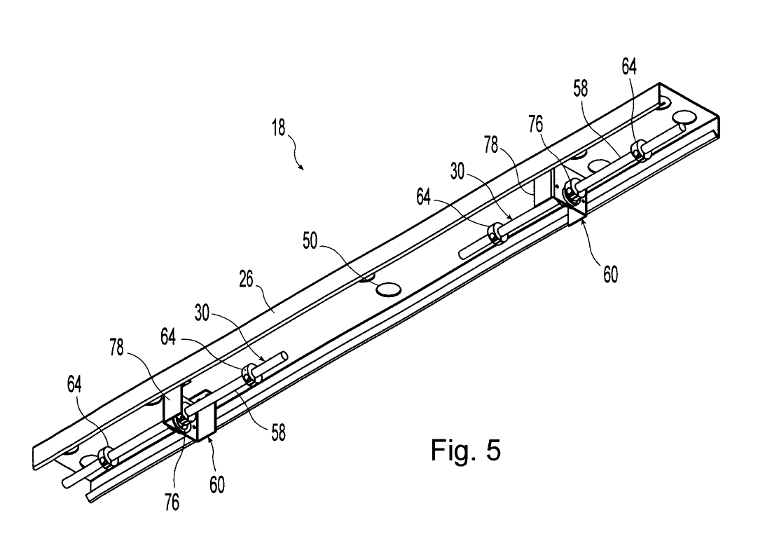

FIGS. 1 to 5 illustrate a vibration isolation system 10 according to the present invention. A vibration source 12 is mounted to a stand 14 on a rooftop 16 by the vibration isolation system 10. The illustrated vibration source 12 is an air conditioning condenser but it is noted that any other suitable vibration source can be used with the vibration isolation system 10. The illustrated vibration isolation system 10 utilizes a pair of vibration isolation assemblies 18. It is noted that a fewer or greater quantity of vibration isolation assemblies 18 can be utilized depending on the requirements of the particular application. The illustrated vibration isolation assemblies 18 are laterally spaced-apart so that they are positioned below lateral sides of the vibration source 12 between the vibration source 12 and the stand 14. The illustrated vibration isolation assemblies 18 are secured to the stand 14 using mechanical fasteners or the like as described in more detail hereinafter but any other suitable fastening means can alternatively be utilized. Each of illustrated vibration isolation assemblies 18 are secured to the vibration source 12 with a pair of attachment brackets 20. The illustrated attachment brackets 20 are each secured to the vibration isolation assemblies using mechanical fasteners 22 or the like but any other suitable fastening means can alternatively be utilized. The illustrated attachment brackets 20 also are each secured to the vibration source 12 using mechanical fasteners 24 or the like but any other suitable fastening means can alternatively be utilized.

The illustrated vibration isolation assemblies 18 are identical and each include a top tray 26 to which the vibration source 12 is secured with the attachment brackets 20, a bottom tray 28 located below the top tray 26 and is secured to the stand 14 or other support structure, and at least one vibration isolator 30 located between the top and bottom trays 26, 28 and operably connected to the top and bottom trays 26, 28. The illustrated vibration isolation assembly 18 includes two of the vibration isolators 30 which are longitudinally spaced apart. It is noted however that a fewer or greater quantity of the vibration isolators 30 can be utilized depending on the requirements of the particular application.

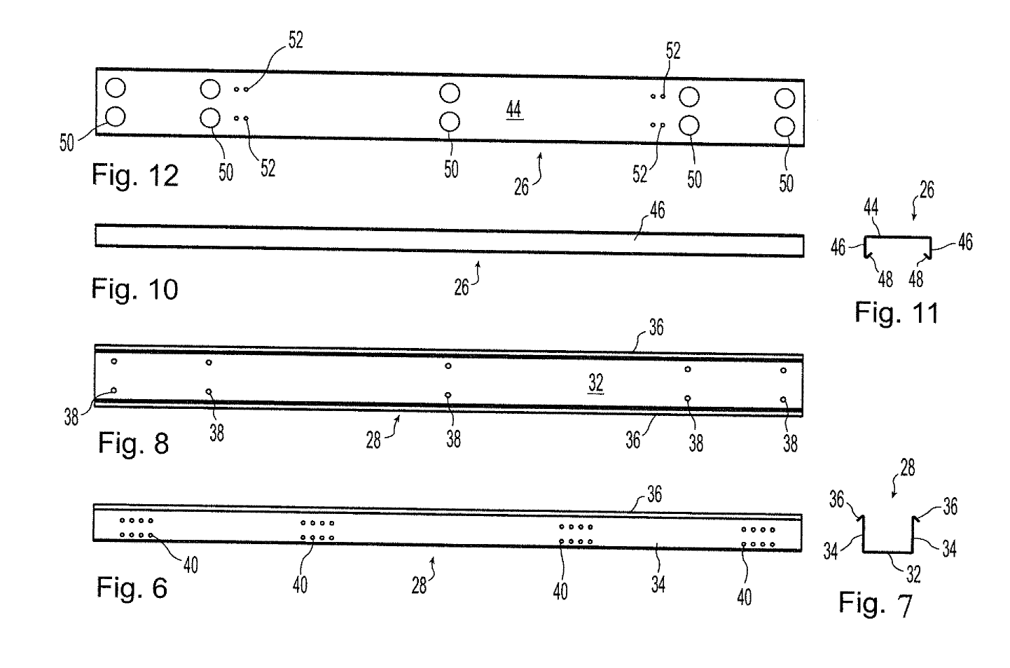

FIGS. 6 to 8 show the bottom tray 28 which is sized and shaped to cooperate with the top tray 26 as described in more detail hereinafter. The illustrated bottom tray 28 is formed of sheet metal such as, for example, 16 gauge steel or the like but can alternatively be formed of any other suitable material and/or formed in any other suitable manner. The illustrated bottom tray 28 is in the form of an elongate upwardly-facing channel and includes a horizontally extending base wall 32, side walls 34 upwardly extending from lateral edges the base wall 32, and flanges 36 extending from upper ends of the side walls 34. The illustrated flanges 36 extend outwardly from the upper ends of the side walls 34 are each at an acute angle relative to horizontal. The illustrated flanges 36 are downwardly inclined in the outward direction at an angle of about 45 degrees. It is noted that any other suitable angle and/or configuration can be alternatively utilized. The illustrated base wall 32 has a plurality of laterally spaced-apart openings 38 sized and shaped for receiving mechanical fasteners to secure the bottom tray 28 to the stand 14. It is noted that the bottom tray 28 can alternatively be secured to the stand 14 in any other suitable manner. The illustrated side walls 34 each have a plurality of longitudinally spaced-apart pairs of vertically spaced apart openings 40 sized and shaped for receiving mechanical fasteners 42 to secure the vibration isolators 30 to the bottom tray 28 as described in more detail hereinbelow. It is noted that the vibration isolators 30 can alternatively be secured to the bottom tray 28 in any other suitable manner.

FIGS. 10 to 12 show the top tray 26 which is sized and shaped to cooperate with the bottom tray 28 as described in more detail hereinafter. The illustrated top tray 26 is formed of sheet metal such as, for example, 16 gauge steel or the like but can alternatively be formed of any other suitable material and/or formed in any other suitable manner. The illustrated top tray 26 is in the form of an elongate downwardly-facing channel and includes a horizontally extending base wall 44, side walls 46 downwardly extending from lateral edges the base wall 44, and flanges 48 extending from lower ends of the side walls 46. The illustrated flanges 48 extend inwardly from the lower ends of the side walls 46 are each at an acute angle relative to horizontal. The illustrated flanges 48 are upwardly inclined in the inward direction at an angle of about 45 degrees. It is noted that any other suitable angle and/or configuration can be alternatively utilized. The flanges 48 are configured to cooperate with the flanges 36 of the bottom tray 28 as described in more detail hereinbelow. The illustrated base wall 44 has a plurality of longitudinally spaced-apart pairs of laterally spaced openings 50 sized and shaped for access to install and remove the mechanical fasteners that secure the bottom tray 28 to the stand 14. The illustrated base wall 44 also has a plurality of longitudinally spaced-apart pairs of openings 52 sized and shaped for receiving mechanical fasteners 54 to secure the vibration isolators 30 to the top tray 26 as described in more detail herein below. It is noted that the vibration isolators 30 can alternatively be secured to the top tray 26 in any other suitable manner.

The illustrated vibration isolators 30 each include a pair of longitudinally spaced-apart bearing supports 56 secured to the bottom tray 28, an elongate elastic member 58 having end portions supported by the pair of supports 56 and capable of bending in response to a load applied to a midportion of the elastic member 58 intermediate the pair of bearing supports 56 to allow oscillation of the elastic member 58 in response to a vibrating load in communication with the elastic member 58, and a connector 60 operably connecting the top tray 26 to the midportion of the flexible member 58 to transfer loads of the vibration source 12 and the top tray 26 to the flexible member 58. The illustrated elastic member 58 is supported solely by the bearing supports 56. The elastic member 58 is capable of deflecting from an original position to a more or less bowed position in response to changes in load in communication with the midportion of the elastic member 58 intermediate its ends, with the amount of the deflection being dependent on the magnitude of the applied force within the load bearing capacity of the elastic member 58. The elastic member 58 is also capable of returning to its original position when the original force acting on the elastic member 58 is restored. See U.S. Pat. Nos. 6,220,563, 6,595,483, and 7,086,509, the disclosures of which are expressly incorporated herein in their entireties by reference, for examples of possible variations of the vibration isolators 30.

The elastic member 58 may comprise any suitable material which allows it to deflect in response to changes in the applied load and return essentially to its original position when the original load is restored. The material of the elastic member 58 can be any suitable metal, plastic, elastomer, composite materials, or the like. The elastic member 58 should be selected to have a static deflection appropriate for the anticipated load, with greater static deflection being required to isolate lower frequency vibrations. The illustrated elastic member 58 is a unitary member of solid round cross-section of any suitable shape can be utilized, including but not limited to hollow tubes, I-beams, or the like. The elastic member 58 can alternatively be a composite member comprising a bundle of continuous elastic subunits held together by any suitable means.

The illustrated bearing supports 56 engage the elastic member 58 at a distance spaced from longitudinal, unrestrained ends of the elastic member 58. Each of the illustrated bearing supports 58 include a sleeve bearing 64 sized and shaped to accommodate the shape and dimensions of the elastic member 58 and reduce friction between the bearing 64 and the elastic member 58 and a mounting bracket 66 for securing the bearing 64 to the bottom tray 28. The illustrated bearing 64 is a discrete element attached to the mounting bracket 66 but alternatively can be formed unitary therewith to form a one-piece component. The illustrated bearing 64 is an ABS bushing but it is noted that it can alternatively comprise any other suitable material and/or form.

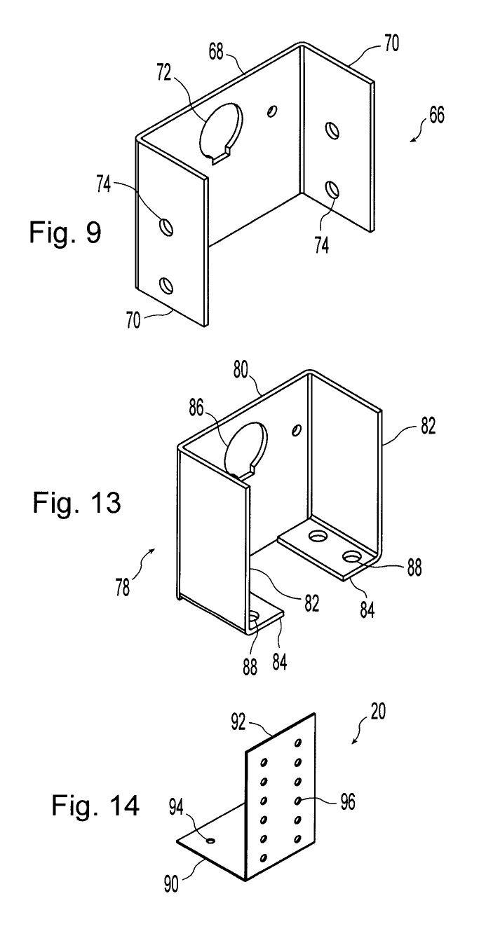

FIG. 9 shows the illustrated bottom mounting bracket 66 which includes a main wall 68 sized and shaped to extend laterally across the channel of the bottom tray 28 and side walls 70 perpendicularly extending from the main wall 68 so that they are generally parallel with and adjacent to the side walls 34 of the bottom tray 28. The illustrated mounting bracket 66 is formed of sheet metal such as, for example, 16 gauge steel or the like but can alternatively be formed of any other suitable material and/or formed in any other suitable manner. The illustrated main wall 68 has a key-shaped opening 72 for receiving the bearing 64 therein in a snap-in manner. It is noted that the bearing 64 can alternatively be secured to the mounting bracket 66 in any other suitable manner. The illustrated side walls 70 each have a pair of vertically spaced apart openings 74 for receiving fasteners 42 therethrough. The openings 74 cooperate with the pairs of vertically spaced apart openings 40 in the side walls 34 of the bottom tray 28. The illustrated mounting brackets 66 have pop rivets extending therethrough but it is noted that any other suitable type of fastening means can alternatively be utilized. The illustrated side walls 34 of the bottom tray 28 are provided with a plurality of the longitudinally spaced-apart pairs of the openings 40 so that the mounting brackets 66 can be placed at different locations to set the active length of the flexible member 58 to accommodate condensers of a variety of different weights. It is not that the bearing 64 can alternatively be secured to the bottom tray 28 in any other suitable manner.

The illustrated connector 60 engages the elastic member 58 at the midportion of the elastic member 58 between the bearing supports 56. The illustrated connector 60 includes a sleeve bearing 76 sized and shaped to accommodate the shape and dimensions of the elastic member 58 and a mounting bracket 78 for securing the bearing 76 to the top tray 26. The illustrated bearing 76 is a discrete element attached to the mounting bracket 78 but alternatively can be formed unitary therewith to form a one-piece component. The illustrated bearing 76 is an ABS bushing but it is noted that it can alternatively comprise any other suitable material and/or form.

FIG. 13 shows the illustrated upper mounting bracket 78 which includes a main wall 80 sized and shaped to extend laterally across the channel of the top tray 26, side walls 82 perpendicularly extending from the main wall 80 so that they are generally parallel with and adjacent to the side walls 46 of the top tray 26, and upper flanges 84 inwardly and perpendicularly extending from upper ends of the side walls 82. The illustrated mounting bracket 78 is formed of sheet metal such as, for example, 16 gauge steel or the like but can alternatively be formed of any other suitable material and/or formed in any other suitable manner. The illustrated main wall 80 has a key-shaped opening 86 for receiving the bearing 76 therein in a snap-in manner. It is noted that the bearing 76 can alternatively be secured to the mounting bracket 78 in any other suitable manner. The illustrated flanges 84 each have a pair of longitudinally spaced-apart openings 88 for receiving fasteners 52 therethrough. The openings 88 cooperate with the pairs of longitudinally spaced-apart openings 52 in the base wall 44 of the top tray 26. The illustrated mounting bracket 78 has pop rivets extending therethrough but it is noted that any other suitable type of fastening means can alternatively be utilized. It is not that the bearing 76 can alternatively be secured to the top tray 26 in any other suitable manner.

The illustrated vibration source 12 is secured to the top trays 26 at each end of the top trays 26 with the attachment brackets 20. FIG. 14 shows the illustrated attachment bracket 20 which includes a horizontally-extending main wall 90 sized and shaped to engage the stand 14 or other support surface and a vertically-extending side wall 92 perpendicularly extending from the main wall 90 and sized and shaped to engage the side of the vibration source 12. The illustrated attachment bracket 20 is formed of sheet metal such as, for example, 16 gauge steel or the like but can alternatively be formed of any other suitable material and/or formed in any other suitable manner. The illustrated main wall 90 has a pair of laterally spaced-apart openings 94 for receiving fasteners 22 therethrough for securing the attachment bracket 20 to the base wall 44 of the top tray 26. The illustrated attachment bracket 20 is secured to the top tray 26 with self-piercing screws but it is noted that the attachment bracket 20 can alternatively be secured to the top tray 26 in any other suitable manner. The illustrated side wall 92 has a plurality of vertically spaced-apart pairs of laterally spaced-apart openings 96 for receiving fasteners 24 therethrough for securing the attachment bracket 20 to the side of the vibration source 12. The illustrated attachment bracket 20 is secured to the vibration source 12 with self-piercing screws but it is noted that the attachment bracket 20 can alternatively be secured to the vibration source 12 in any other suitable manner. The plurality of the pairs of openings 94 is provided so that the attachment bracket 20 can be secured at different heights to accommodate condensers 12 of a variety of different configurations. It is not that the attachment bracket 20 can alternatively have any other suitable configuration and the vibration source 12 can alternatively be secured to the top tray 26 in any other suitable manner.

With the vibration source 12 secured to the top tray 26, the vibration source 12 is placed in communication with the midportion of the elastic member 58. The elastic member 58 bends in response to vibration loads transmitted to it from the vibration source 12. Variations in the load applied to the elastic member 58 cause the elastic member 58 to bear on its bearing supports 56 at different positions along the ends of the elastic member 58. As the load on the elastic member 58 exerts a downward force and the elastic member 58 bows downwardly in response to this load, the length of the midportion of the elastic member 58 extending between the bearing supports 56 increases beyond any dimension caused solely by thermal expansion and contraction. The length of the midportion correspondingly decreases when the downwardly directed force associated with the load decreases. Thus the elastic member 58 oscillates in response to the vibrating load of the vibration source 12 which is transferred to the elastic member 58.

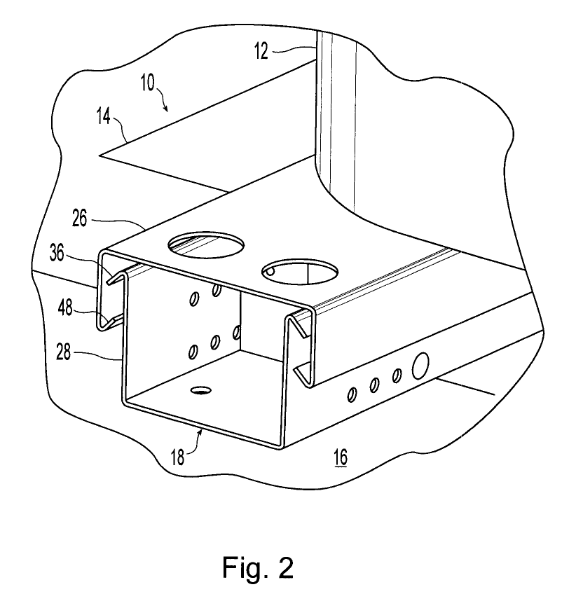

The top and bottom trays 26, 28 are configured so that the flanges 48 of the top tray 26 are adjacent and or engaged with the flanges 36 of the bottom tray 28 and below the flanges 36 of the bottom tray 28 prior to applying the static load of the condenser 12 to the top tray 26 (best seen in FIG. 3). Once the static load of the condenser 12 is applied to the top tray 26, the flanges 48 of the top tray 26 are spaced below the flanges 36 of the bottom tray 28 an amount sufficient to allow the movement of the top tray 26 relative to the bottom tray 28 due to the vibration load of the condenser 12 to the top tray 26 (best seen in FIG. 2). However, when generally-horizontal high wind loads are applied to the vibration source 12, the flanges 48 of the top tray 26 engage the bottom of the flanges 36 of the bottom tray 28 so that the trays 26, 28 are locked together and the wind loads transfer directly through the flanges 48 of the top tray 26 to the flanges 48 of the bottom tray 28 rather than through the vibration isolators 30 (best seen in FIG. 3). As a result, the vibration source 12 can withstand much greater wind loads before failing. It is noted that the illustrated flanges 36 of the bottom tray 28 prevent upward movement of the top tray 26 when the flanges 36, 48 are engaged and the illustrated flanges 36 of the bottom tray 28 prevent horizontal movement of the top tray 26 when the flanges 36, 48 are engaged. The engagement of the flanges 36, 48 prevents movement in both directions perpendicular to the longitudinal axis of the trays 26, 28 because the flanges 36, 48 are angled to provide and interference or interlock in both directions.

The illustrated vibration isolation system 10 has four parallel elastic members 58 in communication with the vibration source 12. However, the vibration source 12 can alternatively be in communication with any other quantity of the elastic members 58 and/or configuration of elastic members 58 depending on the desired requirements for the particular application.

Any of the features or attributes of the above the above described embodiments and variations can be used in combination with any of the other features and attributes of the above described embodiments and variations as desired.

From the foregoing disclosure it will be apparent that the vibration isolation systems 10 according to the present invention provide improved means for isolating vibrations and withstanding high wind loads.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A vibration isolation assembly for mounting a vibration source, said vibration isolation assembly comprising, in combination:
a bottom tray and having a pair of flanges;
a top tray adapted to support the vibration source thereon and having a pair of flanges;
at least one vibration isolator located between the top and bottom trays and secured to the top and bottom trays to isolate vibration produced by the vibration source; and
wherein the flanges of the bottom tray and the flanges of the top tray are spaced apart when loaded by the vibration source to permit movement of the top tray relative to the bottom tray during normal operation of the vibration source and engage when wind loads are applied to the vibration source so that the wind loads transfer through the flanges of the top tray to the flanges of the bottom tray rather than through the vibration isolator.

2. The vibration isolation assembly according to claim 1, wherein the flanges of the bottom tray prevent upward movement of the top tray when engaged.

3. The vibration isolation assembly according to claim 2, wherein the flanges of the bottom tray prevent horizontal movement of the top tray when engaged.

4. The vibration isolation assembly according to claim 1, wherein the vibration isolator includes an elastic member supported by the first and second supports secured to the bottom tray and capable of bending in response to a load applied to a midportion of the elastic member intermediate the first and second supports and connected to the top tray to allow oscillation of the elastic member in response to a vibrating load of the vibration source.

5. The vibration isolation assembly according to claim 1, wherein there are two of the vibration isolators.

6. The vibration isolation assembly according to claim 1, wherein the bottom tray is channel-shaped in cross-section and includes a horizontally extending base wall, side walls upwardly extending from lateral edges the base wall, wherein the flanges of the bottom tray extend from upper ends of the side walls of the bottom tray, wherein the top tray is channel-shaped in cross-section and includes a horizontally extending base wall, side walls downwardly extending from lateral edges the base wall, and wherein the flanges of the top tray extend from lower ends of the side walls of the top tray.

7. The vibration isolation assembly according to claim 6, wherein the flanges of the bottom tray extend outwardly from the upper ends of the side walls, and wherein the flanges of the top tray extend inwardly from lower ends of the side walls of the top tray and are located below the flanges of the bottom tray.

8. The vibration isolation assembly according to claim 7, wherein the flanges of the bottom tray and the flanges of the top tray are each at an acute angle relative to horizontal.

9. The vibration isolation assembly according to claim 1, wherein the flanges of the bottom tray and the flanges of the top tray are each at an acute angle relative to horizontal.

10. A vibration isolation assembly for mounting a vibration source, said vibration isolation assembly comprising, in combination:
an elongate bottom tray which is channel-shaped in cross-section and includes a horizontally extending base wall, side walls upwardly extending from lateral edges the base wall, and flanges extending from upper ends of the side walls;
an elongate top tray which is channel-shaped in cross-section and includes a horizontally extending base wall, side walls downwardly extending from lateral edges the base wall, and flanges extending from lower ends of the side walls;
wherein the base wall of the top tray is adapted to support the vibration source;
a pair of longitudinally spaced-apart vibration isolators located between the top and bottom trays and secured to the top and bottom trays to isolate vibration produced by the vibration source; and
wherein the flanges of the bottom tray and the flanges of the top tray are spaced apart when loaded by the vibration source to permit movement of the top tray relative to the bottom tray during normal operation of the vibration source and engage when wind loads engage the vibration source so that the wind loads transfer through the flanges of the top tray to the flanges of the bottom tray rather than through the vibration isolators.

11. The vibration isolation assembly according to claim 10, wherein the flanges of the bottom tray prevent upward movement of the top tray when engaged.

12. The vibration isolation assembly according to claim 11, wherein the flanges of the bottom tray prevent horizontal movement of the top tray when engaged.

13. The vibration isolation assembly according to claim 10, wherein each of the vibration isolators include an elastic member supported by the first and second supports secured to the bottom tray and capable of bending in response to a load applied to a midportion of the elastic member intermediate the first and second supports and connected to the top tray to allow oscillation of the elastic member in response to a vibrating load of the vibration source.

14. The vibration isolation assembly according to claim 10, wherein the flanges of the bottom tray extend outwardly from the upper ends of the side walls, and wherein the flanges of the top tray extend inwardly from lower ends of the side walls of the top tray and are located below the flanges of the bottom tray.

15. The vibration isolation assembly according to claim 13, wherein the flanges of the bottom tray and the flanges are each at an acute angle relative to horizontal.

16. The vibration isolation assembly according to claim 10, wherein the flanges of the bottom trays and the flanges of the top trays are each at an acute angle relative to horizontal.

17. A vibration isolation system comprising, in combination:
a pair of laterally spaced-apart vibration isolation assemblies;
each of the vibration isolation assemblies comprising:
an elongate bottom tray which is channel-shaped in cross-section and includes a horizontally extending base wall, side walls upwardly extending from lateral edges the base wall, and flanges extending from upper ends of the side walls;
an elongate top tray which is channel-shaped in cross-section and includes a horizontally extending base wall, side walls downwardly extending from lateral edges the base wall, and flanges extending from lower ends of the side walls; and
a pair of longitudinally spaced-apart vibration isolators located between the top and bottom trays and secured to the top and bottom trays to isolate vibration produced by the vibration source; and
a vibration source supported on the top trays of the vibration isolation assemblies;
wherein the flanges of the bottom trays and the flanges of the top trays are spaced apart when loaded by the vibration source to permit movement of the top trays relative to the bottom trays during normal operation of the vibration source and engage when wind loads engage the vibration source so that the wind loads transfer through the flanges of the top trays to the flanges of the bottom trays rather than through the vibration isolators.

18. The vibration isolation system according to claim 17, wherein the flanges of the bottom trays extend outwardly from the upper ends of the side walls of the bottom trays, and wherein the flanges of the top trays extend inwardly from lower ends of the side walls of the top tray and are located below the flanges of the bottom trays.

19. The vibration isolation system according to claim 18, wherein the flanges of the bottom trays and the flanges of the top trays are each at an acute angle relative to horizontal.

20. The vibration isolation system according to claim 17, wherein the vibration source is a condenser.
